(19) United States
(12) Patent Application Publication
(10) Pub. No.: US 2026/0240403 A1
(43) Pub. Date: Aug. 20, 2026

(54) AUTOMATIC TABLEWARE SEPARATION MODULE

(71) Applicant: PRIME.CO.,LTD., Incheon (KR)

(72) Inventors: Sung Hyun KIM, Incheon (KR); Sung Woo KIM, Seoul (KR)

(21) Appl. No.: 19/076,494

(22) Filed: Mar. 11, 2025

(30) Foreign Application Priority Data
Feb. 14, 2025 (KR) 10-2025-0019339

(51) Int. Cl. A47L 15/42

(52) U.S. Cl. CPC A47L 15/42; A47L 2401/04; A47L 2501/36

(57) ABSTRACT

The present disclosure provides an automatic tableware separation module that sequentially separates the lowest tableware from a stack using horizontal rotational motion of a separation component, wherein the separation component comprises: a cylindrical body with a central rotation shaft, multiple screw holes spaced apart along its upper surface, and an extended protruding separation blade that facilitates the sequential separation of the lowest tableware; a width adjustment blade that is screw-attached to the upper surface of the cylindrical body and can be rotated to adjust the separation width by repositioning the screw holes; and a guiding blade that is spirally formed along the outer surface of the cylindrical body to guide the separated tableware downward. The automatic tableware separation module of the present disclosure allows smooth and efficient separation of individual tableware from a stack without the need to replace separation components, accommodating tableware of various thicknesses with ease.

### CROSS REFERENCE TO RELATED APPLICATION

The present application claims priority under 35 U.S.C 119(a) to Korean Patent Application No. 10-2025-0019339, filed in the Korean Intellectual Property Office on February 14, 2025, the entire contents of which is incorporated herein for all purposes by this reference.

### BACKGROUND OF THE DISCLOSURE

### Field of the Disclosure

The present disclosure relates to an automatic tableware separation module that is designed to automatically separate and supply stacked tableware.

### Description of the Related Art

In facilities where large-scale catering is performed, such as schools, public institutions, military bases, and rest stops, a substantial quantity of tableware is used. After meals, the tableware is typically loaded into dishwashers in bulk, where it undergoes cleaning processes, including water spraying and brushing, to remove food residue and leftovers.

However, conventional dishwashers require a conveyor system to supply tableware in a linear manner, which imposes space limitations on dishwasher installation due to the required conveyor length.

To address this issue, Korean Patent No. 1,129,371 discloses a tray separation and supply unit that automatically supplies vertically stacked trays, thereby reducing the required installation space. However, this system uses rotatable tray separation shafts on both sides of the conveyor, with spirally fixed separation guides on the outer surfaces of the shafts. When the shafts rotate, the gaps between the separation guides allow the lowest stacked tray to be separated from the stack and supplied to the conveyor.

However, since the thickness of tableware such as trays, plates, and bowls handled on-site varies depending on the manufacturer, material, or intended use, if the thickness of the tableware is significantly thinner than the gap of the separation guide, more than two pieces of stacked tableware may be separated together, which becomes a factor that hinders the smooth operation of the tableware separation process.

### SUMMARY OF THE DISCLOSURE

The present disclosure aims to address the aforementioned problems by providing an automatic tableware separation module that allows smooth separation of individual tableware pieces from a stack, regardless of their thickness.

To achieve the above objectives, the present disclosure provides an automatic tableware separation module that sequentially separates the lowest tableware from a stack using horizontal rotational motion of a separation component, wherein the separation component comprises: a cylindrical body with a central rotation shaft, multiple screw holes spaced apart along its upper surface, and an extended protruding separation blade that facilitates the sequential separation of the lowest tableware; a width adjustment blade that is screw-attached to the upper surface of the cylindrical body and can be rotated to adjust the separation width by repositioning the screw holes; and a guiding blade that is spirally formed along the outer surface of the cylindrical body to guide the separated tableware downward.

The automatic tableware separation module of the present disclosure allows smooth and efficient separation of individual tableware from a stack without the need to replace separation components, accommodating tableware of various thicknesses with ease.

### BRIEF DESCRIPTION OF THE DRAWINGS

FIG. 1 is a perspective view of an automatic tableware separation module according to an embodiment of the present disclosure.

FIG. 2 is a front view of the automatic tableware separation module according to an embodiment of the present disclosure.

FIG. 3 is a cross-sectional side view of the automatic tableware separation module according to an embodiment of the present disclosure.

FIG. 4 is a perspective view of the separation component of the automatic tableware separation module according to an embodiment of the present disclosure.

FIG. 5 is an exploded perspective view of the separation component of the automatic tableware separation module according to an embodiment of the present disclosure.

FIG. 6 illustrates changes in the separation width when rotating the width adjustment blade in the separation component according to an embodiment of the present disclosure.

### DETAILED DESCRIPTION OF THE DISCLOSURE

The present disclosure allows for various modifications and embodiments. The specific embodiments described in the following drawings and detailed description are provided for illustrative purposes and should not be construed as limiting the disclosure.

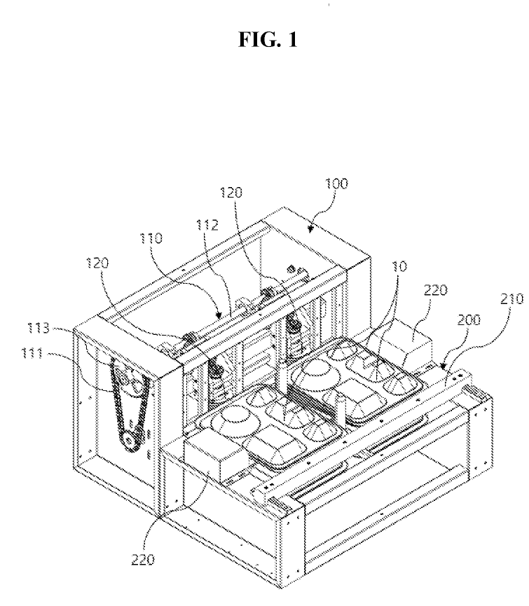

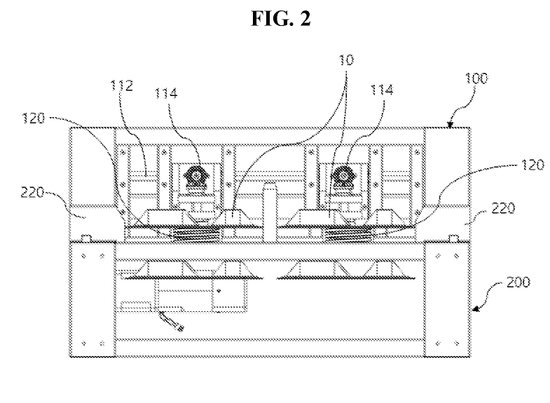

Referring to FIGS. 1 and 2, the automatic tableware separation module includes: a first frame (100) that supports one end of the stacked tableware and houses the separation component (120), which rotates horizontally to separate the lowest tableware; and a second frame (200) that supports the other end of the stacked tableware through a support member (210), allowing the separated tableware to descend.

The automatic tableware separation module according to the present disclosure can be applied to any type of dishwasher, including pre-washers and main washers, as long as the dishwasher requires sequential separation and supply of the lowest tableware from a stack.

Additionally, the tableware in this disclosure includes various dining utensils such as trays, plates, bowls, and cups. However, it is specifically defined as stackable tableware that can be separated through the rotational operation of the separation component. FIGS. 1 to 3 illustrate a tray as an example of the tableware.

The first frame (100) is equipped with a power transmission system (110) and a motor inside its internal space to drive the horizontal rotational motion of the separation component (120). The power transmission system (110) may adopt various mechanisms, such as a chain system, rubber belt system, or gear system.

According to the embodiment illustrated in FIGS. 1 to 3, the motor (not shown) transmits power via a chain (111), which is integrally connected to a shaft gear (113) located at one end of a shaft (112). When the shaft gear (113) receives power, it rotates the shaft (112), which in turn transfers power to a power direction conversion unit (114) via a miter gear connection. This power direction conversion unit (114) redirects the power to the rotation shaft (123), which is centrally formed within the separation component (120), thereby enabling the rotation of the separation component (120).

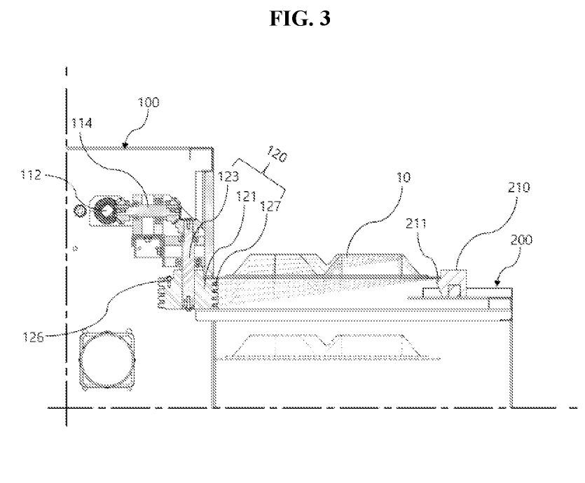

In the present disclosure, the separation component (120) is characterized by a spiral-shaped guiding blade (127) that is formed along the outer circumferential surface of the cylindrical body (121). As shown in FIG. 3, the separation component (120) performs horizontal rotational motion around the rotation shaft (123), sequentially separating the one-side edge of the lowest tableware from the stack.

On the other hand, as depicted in FIG. 3, the opposite edge of the stacked tableware rests on a support member (210), which is protrudingly formed on the upper surface of the second frame (200). The support member (210) serves only to support the opposite edge of the stacked tableware.

Therefore, the automatic tableware separation module according to the present disclosure is characterized in that only one end of the stacked tableware, which is engaged with the separation component (120), is sequentially separated, causing the tableware to gradually tilt from the lowermost layer. When the gradually tilted tableware's end disengages from the lowermost guide blade (127) of the separation component (120), it descends and becomes completely separated. As a result, the automatic tableware separation module of the present disclosure prevents situations where tableware gets stuck in the separation blade (122) or guide blade (127) of the separation component (120), which could otherwise lead to malfunctions. This ensures reliable operation even if the tableware is not placed perfectly horizontally or has slightly warped over long-term use.

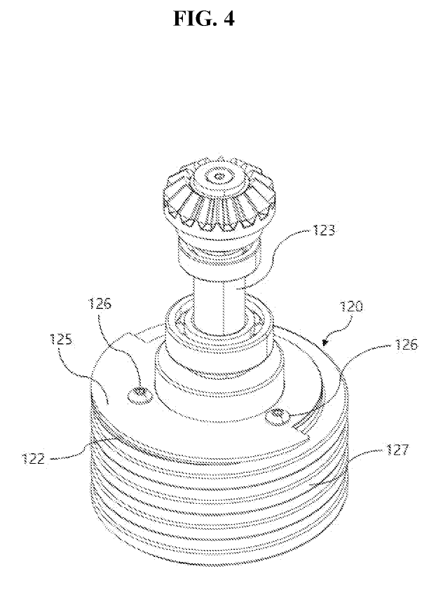

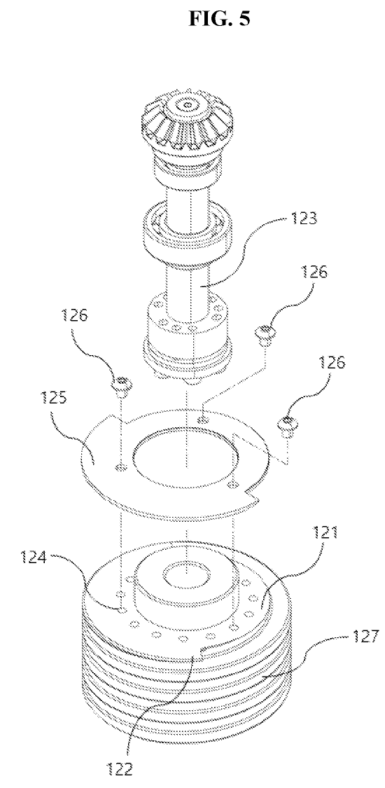

According to FIGS. 4 and 5, the separation component (120) in one embodiment of the present disclosure comprises: a cylindrical body (121), in which a rotation shaft is inserted at the center, and multiple screw holes (124) are spaced apart along the edge of the upper surface. A portion of the upper surface extends outward horizontally, forming a separation blade (122) that sequentially separates individual pieces of tableware starting from the lowest layer of the stacked tableware; a width adjustment blade (125), which is screw-attached to the upper surface of the cylindrical body and remains horizontally aligned with the ground. The width adjustment blade (125) can be rotated horizontally by repositioning the screw holes (124) to adjust the separation width; and a guiding blade (127), which is spirally formed along the outer surface of the cylindrical body (121) to guide the separated tableware downward.

The cylindrical body (121) has a rotation shaft (123) inserted at its center, allowing it to rotate together when the rotation shaft (123) rotates. The material of the cylindrical body (121) is not particularly limited; however, it is preferably made of polyethylene (PE) resin, which is highly durable, wear-resistant, lightweight, and cost-effective.

The cylindrical body (121) is characterized by having a portion of its upper surface extending outward horizontally to form a separation blade (122). This extended separation blade (122) functions to sequentially separate individual pieces of tableware, starting from the lowest layer of the stacked tableware.

According to the embodiment illustrated in FIG. 5, the guiding blade (127) begins at the height of the upper surface of the cylindrical body (121), and half of the upper surface extends outward in a semi-circular shape to form the separation blade (122). This semi-circular extended separation blade (122) remains horizontally aligned with the ground. In this configuration, the width adjustment blade (125) has the widest possible adjustment range, while also ensuring the stabilized guidance of the separated tableware.

The width between the separation blade (122) and the guiding blade (127) determines the maximum thickness of the tableware that can be processed by the automatic tableware separation module according to the present disclosure.

The cylindrical body (121) is formed with multiple screw holes (124) spaced apart along the edge of the upper surface, allowing for the easy attachment and detachment of the width adjustment blade (125) using gap adjustment bolts (126). By selecting different screw holes (124) for attachment, the position of the width adjustment blade (125) can be changed, thereby modifying the separation width. The spacing between the screw holes (124) is not particularly limited; however, to enable fine-tuned width adjustment, it is preferable to minimize the gap between the screw holes (124).

The width adjustment blade (125) is responsible for adjusting the separation width. It is screw-attached to the upper surface of the cylindrical body (121) and remains horizontally aligned with the ground. When adjusting the separation width, the position of the screw holes (124) can be changed, allowing the width adjustment blade (125) to rotate horizontally.

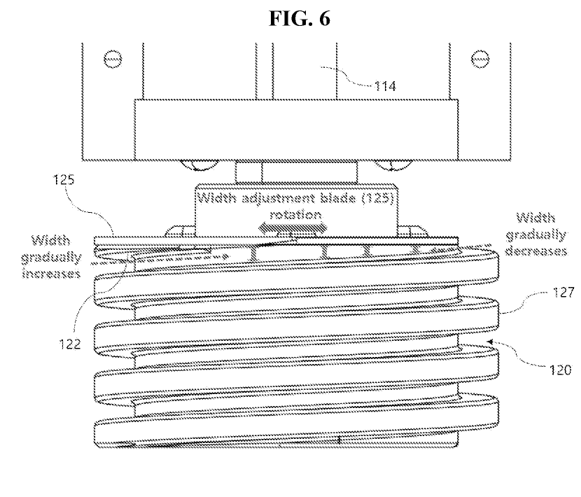

As shown in FIG. 6, when the width adjustment blade (125) is rotated counterclockwise, the width between the width adjustment blade (125) and the guiding blade (127) gradually narrows. Conversely, when the width adjustment blade (125) is rotated clockwise, the width gradually increases. In conventional tableware separation modules using rotational separation blades, if the thickness of the stacked tableware is thinner than the separation blade width, multiple tableware pieces may be separated simultaneously, preventing smooth individual separation. However, in the automatic tableware separation module of the present disclosure, even when the tableware thickness is thinner than the gap between the separation blade (122) and the guiding blade (127), the width adjustment blade (125) can be rotated counterclockwise to reduce the width to match the thickness of the tableware. This allows for smooth individual separation of tableware without replacing the separation component, accommodating various tableware thicknesses with ease.

The shape of the width adjustment blade (125) is not particularly limited; however, it is preferably ring-shaped, with a portion of its circumference extending outward to form a blade. Additionally, to maximize the adjustable width range, as shown in FIG. 5, the width adjustment blade (125) is preferably ring-shaped, with half of its circumference extending outward in a semi-circular shape to form a blade.

Meanwhile, the material of the width adjustment blade (125) is not particularly limited; however, since it supports the stacked tableware and bears the total load of the stacked tableware, it is preferably made of stainless steel, which provides high durability and corrosion resistance.

The guiding blade (127) functions to guide the separated tableware and is spirally formed along the outer surface of the cylindrical body (121) with a certain thickness.

The number of guiding blade (127) layers formed on the separation component (120) is not particularly limited and may be adjusted according to the structure of the automatic tableware separation module. For example, in the automatic tableware separation module illustrated in FIGS. 1 and 2, it is preferable to set the number of guiding blade (127) layers so that, just before the lowest tableware is completely separated and descends, the tilt angle of the tableware (compared to its initial horizontal position) is between 3 and 25 degrees. If the tilt angle is less than 3 degrees, the separation process may not be smooth, causing operational issues. If the tilt angle exceeds 25 degrees, the tableware may tilt too sharply during separation, potentially bending or breaking its edges or causing scratches or damage to surrounding components.

The material of the guiding blade (127) is not particularly limited; however, it is preferably made of polyethylene (PE) resin, which provides high durability, excellent wear resistance, lightweight properties, and cost-effectiveness.

According to FIG. 3, the support member (210) supports the stacked tableware until it smoothly and rapidly separates from the lowest layer of the stacked tableware. The support member (210) is formed with a protruding support ledge (211) that holds the opposite edge of the stacked tableware. The support ledge (211) is preferably angled downward between 30 to 70 degrees (relative to the horizontal plane of the tableware).

Additionally, the support member (210) is preferably horizontally adjustable to accommodate various sizes and types of tableware. The position adjustment mechanism of the support member (210) may utilize a guided system, a roller system, or other well-known adjustment methods.

The automatic tableware separation module of the present disclosure may further include: a tableware detection sensor (not shown) that detects whether tableware is present on the support member (210); and a motor control unit (not shown) that controls the motor operation based on the detection results of the tableware detection sensor. The tableware detection sensor may be any sensor capable of real-time determination of the presence of tableware on the support member (210), including contact sensors, non-contact sensors, and other known sensor types. The sensor detects the presence of tableware and transmits a signal to the motor control unit, which then activates the motor only when tableware is present, thereby preventing unnecessary energy consumption and reducing the risk of accidents.

According to FIGS. 1 and 2, the second frame (200) in the present disclosure preferably includes a side guide member (220) to prevent lateral displacement of the stacked tableware and assist in positioning the tableware. The side guide member (220) is preferably adjustable in the lateral direction, allowing modification of the width of the tableware accommodation area for different sizes of stacked tableware.

What is claimed is:

1. An automatic tableware separation module for sequentially separating a tableware from a stacked arrangement using horizontal rotational motion of a separation component, wherein the separation component comprises:
a cylindrical body with a central rotation shaft inserted, and multiple screw holes spaced apart along an edge of an upper surface; a portion of the upper surface extends outward horizontally to form a separation blade, which separates individual pieces of tableware starting from the lowest layer of stacked tableware;
a width adjustment blade that is screw-attached to the upper surface of the cylindrical body, remains horizontally aligned, and can be rotated horizontally to adjust a separation width by changing a position of the screw holes; and
a guiding blade, which is spirally formed along an outer surface of the cylindrical body to guide a separated tableware downward.

2. The automatic tableware separation module of claim 1, wherein the cylindrical body has a semi-circular extended separation blade that is horizontally positioned.

3. The automatic tableware separation module of claim 1, wherein the width adjustment blade is ring-shaped with an extended cutting edge.

4. The automatic tableware separation module of claim 1, wherein the width adjustment blade is made of stainless steel.

5. The automatic tableware separation module of claim 1, wherein the guiding blade is made of polyethylene (PE) resin.
